(19) United States
(12) Patent Application Publication
(10) Pub. No.: US 2024/0025717 A1
(43) Pub. Date: Jan. 25, 2024

(54) VEHICLE CONTROL DEVICE AND METHOD

(71) Applicant: Hitachi, Ltd., Tokyo (JP)

(72) Inventors: Kentaro YOSHIMURA, Tokyo (JP); Natsumi WATANABE, Tokyo (JP); Masaya ITOH, Tokyo (JP); Tatsuya ONO, Tokyo (JP)

(21) Appl. No.: 18/032,197

(22) PCT Filed: Oct. 22, 2021
(86) PCT No.: PCT/JP2021/039042

§ 371 Date: Apr. 17, 2023

(30) Foreign Application Priority Data
Nov. 30, 2020 (JP) 2020-198315

(51) Int. Cl. B66F 17/00; B66F 9/06

(52) U.S. Cl. CPC B66F 17/003; B66F 9/063; B66F 9/0755

(57) ABSTRACT

An object of the present invention is to safely and efficiently execute operation such as cargo handling in a cargo vehicle such as an automatic forklift 1. In order to achieve the above object, in the present invention, a laser scanner 2 that monitors a vehicle safety monitoring range 4 and laser curtains 21 that monitor a safety monitoring area 211 are prepared, and these are caused to function in cooperation with each other according to a status of operation of the automatic forklift 1. As one aspect of this, in the present invention, in a case where the safe state in the safety monitoring area 211 is confirmed using the laser curtains 21 at the time of executing cargo handling, a vehicle safety monitoring invalidation range 41 is set by invalidating the vehicle safety monitoring range 4 by the laser scanner 2.

### TECHNICAL FIELD

The present invention relates to a technique for controlling a cargo vehicle that handles cargos.

### BACKGROUND ART

Currently, cargo vehicles that handle cargos are used in distribution and production sites. As operation, the cargo vehicle executes movement (traveling) in which the cargo vehicle itself moves and cargo handling of cargos. PTL 1 has been proposed as a technique related to control of a cargo vehicle. PTL 1 discloses a technique related to an automatic forklift that travels and performs cargo handling in an unmanned manner. Here, when a cargo vehicle executes cargo handling, a worker (person) may perform support work, or the cargo vehicle cooperate with another cargo vehicle or device (robot, or the like). In addition, there may be obstacles such as other cargos or dust that are not a cargo handling target, in a work area. Note that these are referred to as foreign matters.

For example, an environment in which the automatic forklift operates is often an environment mixed with workers such as a warehouse, a factory, and a harbor. PTL 2 and NPL 1 have been proposed as techniques for achieving safety in such an environment mixed with foreign matters including an environment mixed with humans.

For this reason, PTL 2 discloses a technique related to a safety monitoring unit around a forklift when the forklift travels, a setting unit that sets a warning area in a monitoring area of the safety monitoring unit on the basis of a traveling state (such as a steering angle and speed) of the forklift, and a safety device of the forklift that performs a predetermined action (such as alarm sounding) when a worker enters the warning area.

In addition, NPL 1 discloses procedure when a forklift invalidates a safety monitoring unit (Personnel Detection Means in the literature). In other words, NPL 1 discloses invalidating the safety monitoring unit after sufficiently approaching a cargo and moving at an extremely low speed in an invalidated state.

### CITATION LIST

### Patent Literature

PTL 1: JP 2017-019596 A
PTL 2: JP 2016-194481 A

### Non Patent Literature

NPL 1: ISO 3691-4 Industrial trucks-Safety requirements and verification Part 4: Driverless industrial trucks and their systems, 4.8.2.3 Muting of the personnel detection means, pp. 16, First edition 2020-02.

### SUMMARY OF INVENTION

### Technical Problem

In PTL 2 in which safety is ensured in a mixed environment, it is necessary to sufficiently approach a pallet in a case where a forklift performs cargo handling work, particularly in a case where a fork claw is pierced into the pallet. It is therefore necessary to temporarily invalidate the safety monitoring unit mounted on the forklift. In addition, in NPL 1, if the safety monitoring unit is invalidated in a case where there is a worker around, the worker cannot be detected thereafter.

In other words, in PTL 2 and NPL 1, it is difficult to achieve both safety monitoring and efficiency improvement of cargo handling at the time of cargo handling in a mixed environment as follows. When a sensor of the cargo vehicle is in operation while the cargo vehicle is performing cargo handling, it is not possible to distinguish between the cargo to be handled and a worker, or the like. In other words, the cargo is erroneously recognized as a worker, or the like, and the cargo handling cannot be further performed. On the other hand, when the cargo vehicle performs cargo handling, if the sensor of the cargo vehicle is not in operation, approach of a worker, or the like, and danger cannot be detected.

Thus, an object of the present invention is to enable safety monitoring around a location where cargos are handled and improvement of efficiency of cargo handling even in a mixed environment in which a worker, or the like, and the cargo vehicle are mixed.

### Solution to Problem

In order to solve the above problems, in the present invention, a first safety monitoring device configured to monitor a vehicle safety monitoring range and a second safety monitoring device configured to monitor a safety monitoring area are prepared, and the first safety monitoring device and the second safety monitoring device are caused to function in cooperation with each other in accordance with a status of operation of a cargo vehicle. As one aspect of this, in the present invention, the vehicle safety monitoring range by the first safety device is changed in a case where a safe state in the safety monitoring area is confirmed using the second safety monitoring device at the time of executing cargo handling. Note that this change includes invalidation.

More specifically, a vehicle control device that controls operation including movement and cargo handling in a cargo vehicle includes: an arithmetic processing unit configured to generate a control instruction for controlling the operation; a communication unit connected to a travel control device that controls travel of the cargo vehicle and a cargo handling control device that controls cargo handling operation of the cargo vehicle and configured to output the control instruction; and an input/output unit connected to a first safety monitoring device capable of monitoring a vehicle safety monitoring range and outputting safe state data for stopping operation of the cargo vehicle, and in a case where a monitoring result of a safety monitoring area covering the vehicle safety monitoring range by a second safety monitoring device indicates a safe state when cargo handling by the cargo vehicle is executed, the arithmetic processing unit enables execution of the cargo handling by the cargo vehicle by changing the vehicle safety monitoring range.

Further, the present invention also includes a vehicle control method using a vehicle control device. Still further, the present invention also includes a program for causing the vehicle control device to function and a storage medium storing the program.

### Advantageous Effects of Invention

According to the present invention, it is possible to safely and efficiently execute operation such as cargo handling in a cargo vehicle.

### BRIEF DESCRIPTION OF DRAWINGS

FIG. 1 is a view illustrating a configuration of an automatic forklift according to related art.

FIG. 2 is a view illustrating a safety monitoring state when the automatic forklift of related art illustrated in FIG. 1 travels.

FIG. 3 is a view illustrating a safety monitoring state at the time of cargo handling of the automatic forklift of related art illustrated in FIG. 1.

FIG. 4 is a view illustrating a cargo handling work state of the automatic forklift according to a first embodiment of the present invention.

FIG. 5 is a view illustrating details of a vehicle control device according to the first embodiment of the present invention and configurations of various devices cooperating with the vehicle control device.

FIG. 6 is a flowchart for explaining processing procedure of a vehicle control device 11 according to the first embodiment of the present invention.

FIG. 7 is a view illustrating a cargo handling work state of an automatic forklift according to a second embodiment of the present invention.

FIG. 8 is a view illustrating a cargo handling work state of an automatic forklift according to a third embodiment of the present invention.

FIG. 9 is a view illustrating a cargo handling work state of the automatic forklift according to a fourth embodiment of the present invention.

FIG. 10 is a view illustrating management data to be used in the first embodiment of the present invention.

### DESCRIPTION OF EMBODIMENTS

Hereinafter, each embodiment will be described with reference to the drawings. In each embodiment, control including safety monitoring of an automatic forklift will be described as an example.

However, these embodiments are merely examples, and the present invention can be applied to other than safety monitoring of an automatic forklift. Applications of the present invention include a cargo vehicle, particularly, a cargo vehicle that performs automated driving.

Here, cargo handling includes loading, unloading, and installation of cargos. Further, the cargo vehicle includes a crane truck and a ship in addition to a force lift top lifter and a crane vehicle (mobile crane). Furthermore, the cargo vehicle also includes a so-called robot that is movable and performs cargo handling. In addition, the cargo vehicle of the present invention is used in a warehouse, a factory, a harbor, and the like, and the place thereof is not limited.

### First Embodiment

Hereinafter, a first embodiment of the present invention will be described by taking control of an automatic forklift that performs cargo handling as an example.

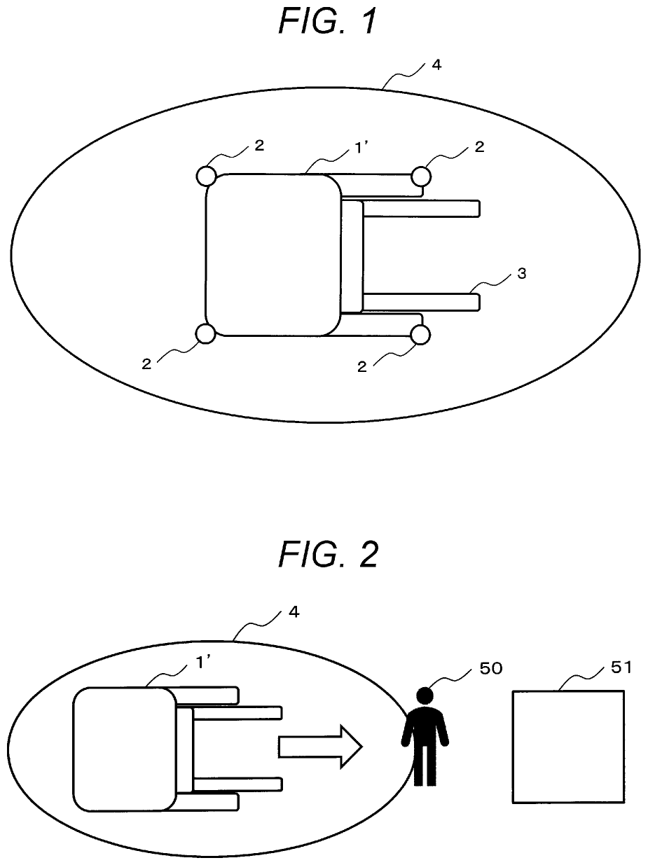

FIG. 1 is a view illustrating a configuration of an automatic forklift 1′ according to related art. The automatic forklift 1′ includes a laser scanner 2 installed on a vehicle body and a cargo handling device 3 for performing cargo handling. The cargo handling device 3 includes a mast and a hydraulic device (or an electric device) and can move a fork claw forward and backward, lift and lower a cargo mounted on the fork, and tilt the cargo. In other words, the cargo handling device 3 can perform reach operation of the fork, rising and lowering operation of the mast, and tilting operation. Similarly to an automatic forklift 1 described later, the automatic forklift 1′ operates in an unmanned manner and is a reach-type forklift. The laser scanner 2 detects an obstacle around the automatic forklift 1′. For this purpose, a vehicle safety monitoring range 4 is set in the laser scanner 2. With this configuration, the vehicle control device (not illustrated) of the automatic forklift 1′ can monitor whether or not there is a foreign matter such as an obstacle in the vehicle safety monitoring range 4. In other words, by using the laser scanner 2, the vehicle control device can detect whether there is a foreign matter in the vehicle safety monitoring range 4 specified within a predetermined distance such as an irradiation range of the laser.

FIG. 2 is a view illustrating a safety monitoring state when the automatic forklift 1′ of related art illustrated in FIG. 1 travels. The automatic forklift 1′ is moving to grip a pallet 51, which is a type of a cargo placed on the floor. Specifically, the automatic forklift 1′ approaches the pallet 51 with a fork claw of the cargo handling device 3 in front. Then, a worker 50 exists between the automatic forklift 1′ and the pallet 51, and the worker 50 is included in the range of the vehicle safety monitoring range 4 as the automatic forklift 1 moves. Then, the laser scanner 2 detects the worker 50, and the vehicle control device stops the automatic forklift 1′.

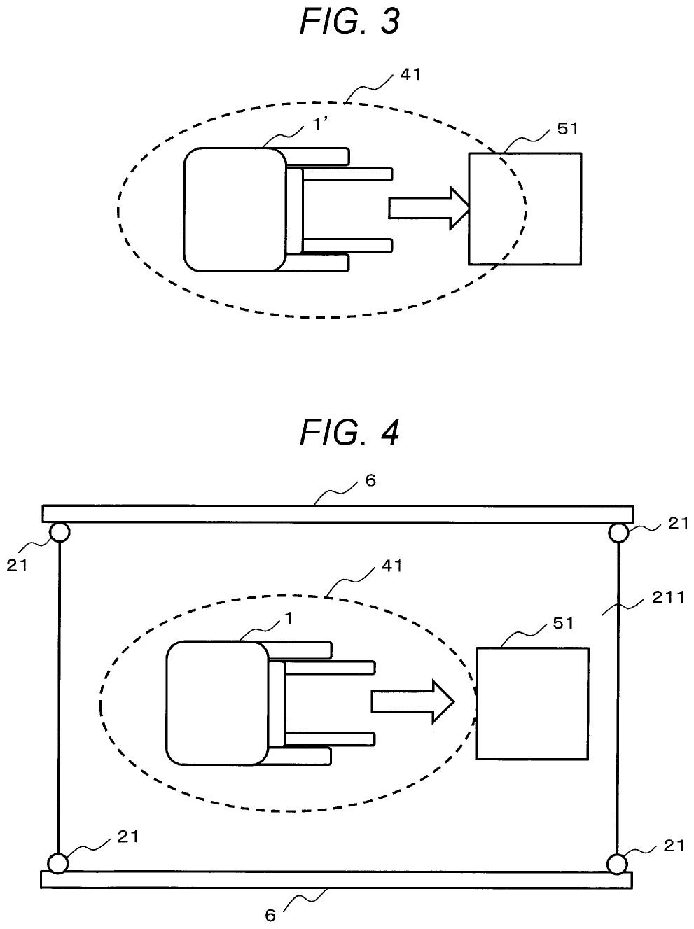

Next, FIG. 3 is a view illustrating a safety monitoring state at the time of cargo handling of the automatic forklift illustrated in FIG. 1. When the automatic forklift 1′ approaches the pallet 51 sufficiently, i.e. to lift the pallet 51, the vehicle control device changes setting of the laser scanner 2 and invalidates the vehicle safety monitoring range 4. In FIG. 3, the invalidated vehicle safety monitoring range is illustrated as a vehicle safety monitoring invalidation range 41. Here, in the automatic forklift 1′ of related art, the laser scanner 2 can detect whether or not there is a foreign matter such as an obstacle, but cannot determine whether the detected foreign matter is the pallet 51 or a human such as the worker 50.

Thus, in the automatic forklift 1′ of related art, if the laser scanner 2 or the vehicle safety monitoring range 4 by the laser scanner 2 is kept validated, the vehicle control device stops operation of the automatic forklift 1′ as a result of a safety function operating in response to detection of the foreign matter. In other words, the automatic forklift 1′ cannot contact the pallet 51 and cannot perform cargo handling work. Conversely, if the vehicle safety monitoring range 4 by the laser scanner 2 is invalidated, that is, the vehicle safety monitoring invalidation range 41 is set, the automatic forklift 1′ does not stop even if the automatic forklift 1′ approaches the pallet 51, and a foreign matter around the pallet 51 cannot be detected. In other words, there is a risk of an accident such as collision with a foreign matter.

As described above, in the cargo vehicle of related art such as the automatic forklift 1′, there is a problem that, at the time of performing the cargo handling work, if priority is given to safety, operation including the cargo handling is stopped, and if priority is given to execution of the cargo handling, the safety is impaired. Thus, in the present embodiment, both of them are achieved.

FIG. 4 is a view illustrating a cargo handling operation state of the automatic forklift 1 according to the present embodiment. In the present embodiment, a wall 6 is provided around the pallet 51 and four laser curtains 21 are provided on the wall 6 to constitute a pallet location, that is, a safety monitoring area 211 related to cargo handling of the automatic forklift 1. In other words, the safety monitoring area 211 is partitioned by the wall 6 and the laser light of the laser curtains 21 facing each other. Although the safety monitoring area 211 is not directly irradiated with the laser light, the safety monitoring area 211 is a monitoring area of the laser curtains 21, that is, a detection area of a foreign matter. As described above, in the present embodiment, a sensor represented by the laser curtains 21 is provided outside the automatic forklift 1, but the present invention is not limited to this installation location. In addition, the safety monitoring area 211 is desirably formed to be the same as or include the vehicle safety monitoring range 4. This is because if the safe state is secured in the safety monitoring area 211 covering the vehicle safety monitoring range 4, it can be determined that the state of the vehicle safety monitoring range 4 is also secured. However, the laser light, that is, the irradiation range of the laser curtains 21 may be set as the safety monitoring area 211.

The laser curtains 21 monitor intrusion of an object into the safety monitoring area 211. In other words, the laser curtains 21 detect a foreign matter in the safety monitoring area 211. However, in the present embodiment, as a result of the laser curtains 21 having a muting function, it is set such that intrusion of the automatic forklift 1 is not detected and intrusion of a foreign matter such as the worker 50 is detected. Thus, in a case where safety of the pallet place is monitored by the laser curtains 21 under the control of the vehicle control device 11 of the automatic forklift 1, the automatic forklift 1 invalidates the laser scanner 2 mounted on the automatic forklift 1 and performs the cargo handling work. Although FIG. 4 illustrates one automatic forklift 1 in the safety monitoring area 211, a plurality of automatic forklifts 1 may operate in the area.

As described above, in the present embodiment, two types of sensors including the laser scanner 2 and the laser curtains 21 are used. However, the present invention is not limited thereto, and a first safety monitoring device represented by the laser scanner 2 and a second safety monitoring device represented by the laser curtains 21, each of which can detect a foreign matter, can be used. In the laser scanner 2, the first safety monitoring device and the second safety monitoring device output safe state data indicating a safe state including a safety signal. On the basis of the safe state data, the vehicle control device 11 creates a control command including stop of the automatic forklift 1. In particular, in a case where the safe state is not confirmed, the safe state data indicates stop of operation of the automatic forklift 1.

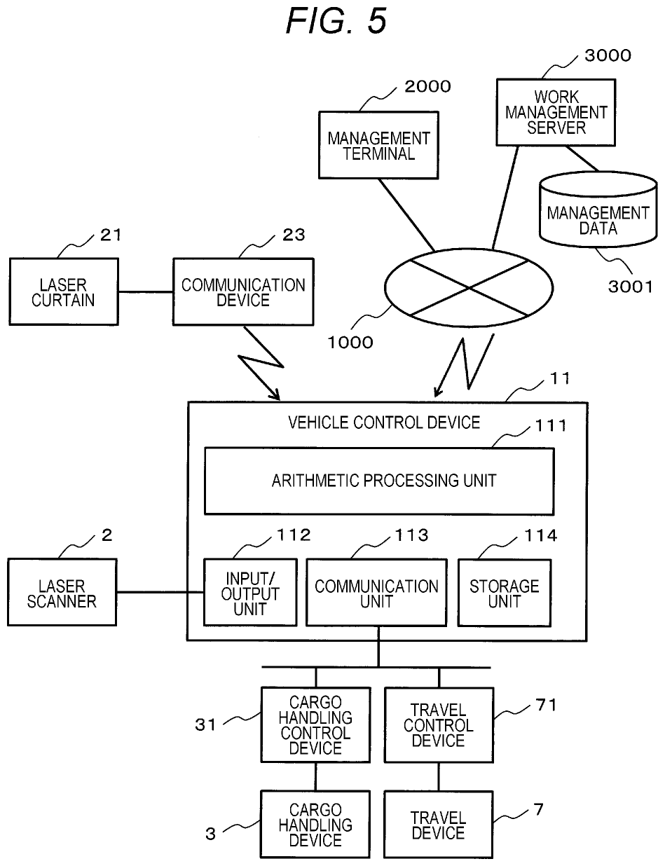

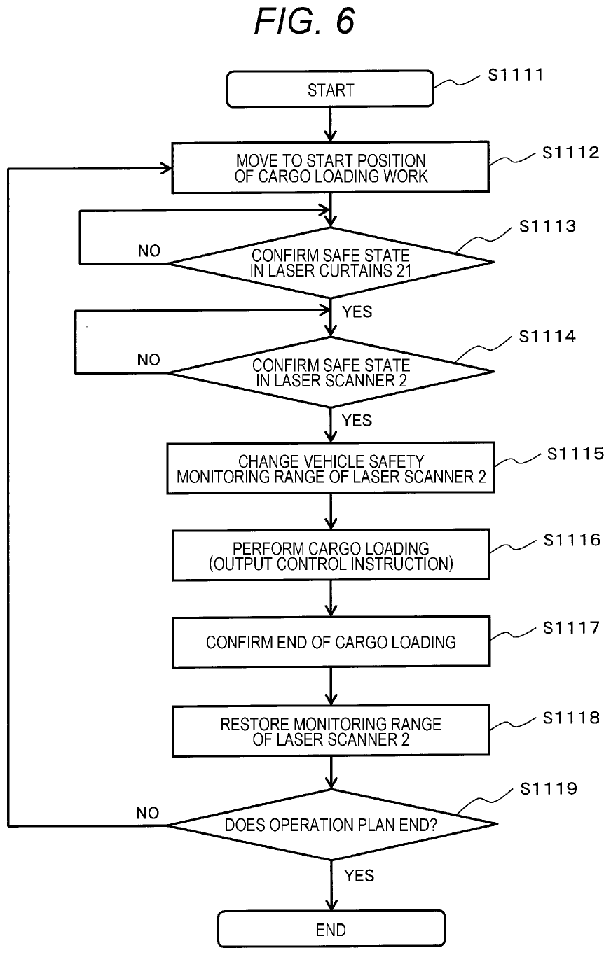

Hereinafter, the vehicle control device 11 and various devices cooperating with the vehicle control device 11 will be described. FIG. 5 is a view illustrating details of the vehicle control device 11 according to the present embodiment and configurations of various devices cooperating with the vehicle control device 11. The vehicle control device 11 executes information processing for controlling traveling operation and cargo handling operation of the automatic forklift 1. The vehicle control device 11 includes an arithmetic processing unit 111 configured to execute software by a CPU, and an input/output unit 112 capable of communicating with other devices and configured to input and output a digital signal, an analog signal, and the like. Furthermore, the vehicle control device 11 includes a communication unit 113 configured to perform processing such as control area network (CAN) and wireless communication, and a storage unit 114 configured to store programs and control data. Then, the arithmetic processing unit 111 creates a “control instruction” for controlling operation of the automatic forklift 1 according to the program. The content of this processing will be described later with reference to FIG. 6. Note that this program is distributed via a network 1000 or is read from a storage medium and stored in the storage unit 114.

In addition, the laser scanner 2 monitors, that is, detects whether or not there is a foreign matter such as an obstacle in the vehicle safety monitoring range 4. In a case where an obstacle, or the like, is not detected within the vehicle safety monitoring range 4, that is, normally, a safety signal is output to the input/output unit 112. In a case where an obstacle is detected or in a case where a failure occurs in the laser scanner, output of the safety signal is stopped. The vehicle control device 11 uses the arithmetic processing unit 111 to determine that a foreign matter has been found, the laser scanner 2 has failed, or communication with the laser scanner 2 cannot be performed on the basis of stop of the safety signal. In other words, it is determined that the safe state is lost using the arithmetic processing unit 111. If such a determination is made, the arithmetic processing unit 111 creates a stop instruction for stopping the operation of the automatic forklift 1. As described above, the laser scanner 2 functions as a traveling sensor of the automatic forklift 1.

Although the laser scanner 2 is desirably installed in the automatic forklift 1, the laser scanner 2 only needs to exhibit the above-described function and is not limited thereto. In addition, a scanner or a monitoring device using a medium other than a laser may be used to detect a foreign matter. For example, an infrared ray, an ultrasonic wave, a millimeter wave radar, or the like, may be used as the medium. In addition, a camera may be used as a monitoring device, and a foreign matter may be monitored with an image. Furthermore, the number of laser scanners 2 is not limited.

The cargo handling control device 31 is provided in the automatic forklift 1 and is connected to the vehicle control device 11 via a communication network. The cargo handling control device 31 controls the cargo handling device 3 in response to a control instruction from the vehicle control device 11. Specifically, the cargo handling control device 31 controls reach operation of the fork, rising and lowering operation of the mast, tilting operation, and the like. In other words, the cargo handling control device 31 mainly controls cargo handling operation of the automatic forklift 1.

A travel control device 71 is provided in the automatic forklift 1 and is connected to the vehicle control device 11 via a communication network. The travel control device 71 controls a travel device 7 in response to a control instruction from the vehicle control device 11. Specifically, the travel control device 71 controls forward movement, backward movement, stop, steering, and the like, of the fork. In other words, the travel control device 71 mainly controls movement of the automatic forklift 1.

The laser curtains 21 detect whether or not there is a foreign matter in the set safety monitoring area 211.

In a case where a foreign matter such as an obstacle is not detected in the safety monitoring area 211, the laser curtains 21 output a safety signal to the communication device 23. The communication device 23 transmits the safety signal to the input/output unit 112 of the vehicle control device 11 by wireless communication, or the like. In this manner, the laser curtains 21 function as a cargo handling sensor of the automatic forklift 1. Note that communication between the communication device 23 and the vehicle control device 11 may be connected via a network 1000.

In the present embodiment, the input/output unit 112 exchanges information between the laser scanner 2 and the communication device 23 or a network 1000 to be described later, but a communication unit may be separately provided.

Here, in a case where a foreign matter such as an obstacle is detected in any of the laser curtains 21 or in a case where a failure occurs in any of the laser curtains 21, output of the safety signal is stopped. The vehicle control device 11 uses the arithmetic processing unit 111 to determine that a foreign matter such as an obstacle has been found, the laser curtain 21 has failed, or wireless communication has been interrupted, on the basis of stop of the safety signal. In other words, the arithmetic processing unit 111 determines that the safe state is lost.

Note that while in the present embodiment, the laser curtains 21 are used, other scanners and monitoring devices may be used similarly to the laser scanner 2. In the present embodiment, four laser curtains 21 are installed on the wall, but the number of laser curtains and the installation location are not limited. Furthermore, a tag sensor may be provided in the safety monitoring area 211. The tag sensor is configured to output a safety signal in a case where a person or an object holding or installed a predetermined tag (such as an RFID and an IC card) enters.

Then, in a case where the tag sensor detects a foreign matter not holding or not installed with the tag, output of the safety signal is stopped. Similarly to the laser curtains 21, the tag sensor does not have to output the safety signal and only requires to output a signal that can determine the detection result of the foreign matter.

Furthermore, in the laser curtains 21, or the like, whether or not there is a foreign matter in the safety monitoring area 211 may be detected, or these may be installed near an entrance to detect entry and exit of a foreign matter into and from the safety monitoring area 211. In the latter case, the laser curtains 21, or the like, detect entry and exit. Then, the vehicle control device 11, or the like, determines whether a foreign matter remains in the safety monitoring area 211 at the time of cargo handling. An example of the laser curtains 21 will be described in a third embodiment.

In the present embodiment, the vehicle control device 11 is connected to a management terminal 2000 and a work management server 3000 via a network 1000. In the present embodiment, this connection is made via the input/output unit 112, but the above-described communication unit may be used. The network 1000 only needs to be able to communicate with the management terminal 2000 and the work management server 3000. However, information related to control of operation of the automatic forklift 1 is communicated, so that it is desirable to ensure security.

Next, the work management server 3000 is implemented by a computer such as a server and is connected to the vehicle control device 11 via the network 1000. In the present embodiment, as processing for controlling operation of the automatic forklift 1, a control command called a so-called safety control system is created, but the work management server 3000 can perform at least part of the processing. Furthermore, the vehicle control device 11 may perform processing of the safety control system, and the work management server 3000 may perform processing of a so-called planning/intelligence system. More specifically, the work management server 3000 desirably creates a plan of the operation of the automatic forklift 1 and optimizes the entire operation. On the other hand, the vehicle control device 11 desirably creates a control command called a safety control system. Note that sharing of the processing between the work management server 3000 and the vehicle control device 11 is not limited to the above-described example.

For example, these kinds of processing may be collectively performed by any one of the work management server 3000 and the vehicle control device 11.

In a case where the work management server 3000 creates the control command, the vehicle control device 11 performs relay among the work management server 3000, the cargo handling control device 31, and the travel control device 71. It is particularly suitable in a case where the work management server 3000 is used and in a case where a plurality of automatic forklifts 1 are present in the safety monitoring area 211. Next, processing of the present embodiment described with reference to FIG. 6 will be described focusing on creation of a control command in order to simplify the description.

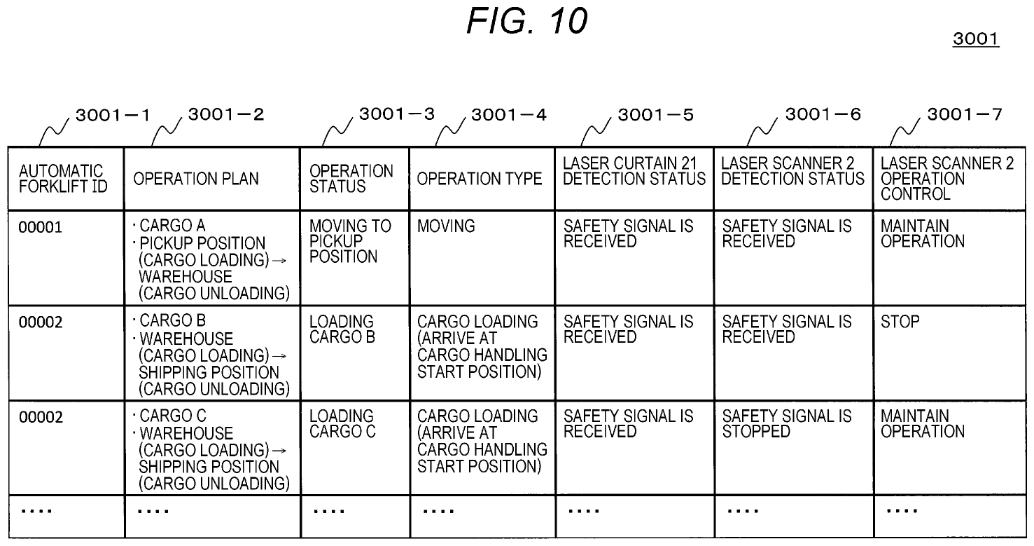

Furthermore, the work management server 3000 stores, in the storage device, management data 3001 to be used in the above-described processing related to the automatic forklift 1, particularly, the processing of the planning/intelligence system. The management data 3001 is illustrated in FIG. 10. The management data 3001 includes the following items for each automatic forklift. These are an automatic forklift ID 3001-1, an operation plan 3001-2, an operation status 3001-3, an operation type 3001-4, a laser curtain 21 detection status 3001-5, a laser scanner 2 detection status 3001-6, and laser scanner 2 operation control 300-7.

Here, the automatic forklift ID 3001-1 is information for identifying the automatic forklift 1. In addition, the operation plan 3001-2 is information indicating a plan regarding movement and cargo handling of the corresponding automatic forklift 1. As illustrated in the drawing, the operation plan desirably includes a cargo to be handled and a movement route thereof. The movement route includes a departure position and a destination position.

In addition, the operation type 3001-4 is an item indicating content of the operation of the corresponding automatic forklift 1 at that time. The operation type 3001-4 is an item indicating whether the operation in the operation status 3001-3 is moving or cargo handling. The laser curtain 21 detection status 3001-5 is an item indicating whether the laser curtains 21 in the safety monitoring area 211 where the corresponding automatic forklift 1 is located output a safety signal, that is, have detected a foreign matter.

The laser scanner 2 detection status 3001-6 is an item indicating whether the laser scanner 2 of the corresponding automatic forklift 1 outputs a safety signal, that is, has detected a foreign matter.

Further, the operation control 3001-7 of the laser scanner 2 is an item indicating a change result of the vehicle safety monitoring range 4 of the laser scanner 2. In order to specify this change result, the work management server 3000 uses the operation type 3001-4, the laser curtain 21 detection status 3001-5, and the laser scanner 2 detection status 3001-6. In the present embodiment, maintain operation (no change) or stop (change) of the laser scanner 2 is used as the change result of the vehicle safety monitoring range 4. The change of the vehicle safety monitoring range 4 will be described later with reference to the flowchart of FIG. 6.

The management terminal 2000 is a computer to be used by an administrator who manages the operation of the automatic forklift 1. Thus, the management terminal 2000 displays operation content (control result) and an operation plan of the automatic forklift 1. In addition, the administrator may input operation content (control result) and an operation plan to the management terminal 2000, and the automatic forklift 1 may operate in accordance therewith. Note that the configuration in FIG. 5 is also used in other embodiments.

Next, FIG. 6 is a flowchart for explaining processing procedure of the vehicle control device 11 in the present embodiment. In this flowchart, the processing starts from step S1111. For this purpose, the vehicle control device 11 receives a record of the corresponding automatic forklift 1 in the management data 3001 transmitted from the work management server 3000 via the network 1000 using the input/output unit 112. Then, the arithmetic processing unit 111 transmits an activation instruction to the laser scanner 2, the cargo handling control device 31, and the travel control device 71 via the input/output unit 112. As a result, the laser scanner 2 operates. In addition, the cargo handling device 3 and the travel device 7 of the automatic forklift 1 can operate.

Then, the arithmetic processing unit 111 notifies the cargo handling control device 31 and the travel control device 71 of an operation instruction to operate according to the operation plan 3001-2 of the received management data 3001.

As a result, the automatic forklift 1 moves to a cargo handling start position by operating the cargo handling device 3 and the travel device 7. Note that the automatic forklift 1 moves the cargo handling device 3 to a position for movement in a case where the cargo is already loaded on the fork, but operation of the cargo handling device 3 may be omitted in other cases.

In this step, the vehicle control device 11 may detect operation start time to start this processing. In addition, the storage unit 114 of the automatic forklift 1 may store a record of the automatic forklift 1 as the management data 3001. In this case, in this step, the arithmetic processing unit 111 reads the operation plan 3001-2 out of the management data from the storage unit 114. In the following description, it is assumed that the management data 3001 (corresponding to the record of the automatic forklift 1) is stored in the storage unit 114.

Next, in step S1112, the arithmetic processing unit 111 controls movement of the automatic forklift 1 to the cargo handling start position. In other words, the arithmetic processing unit 111 outputs to the travel control device 71, a control instruction to move to a place suitable for piercing the fork claw into the pallet 51 to be subjected to the cargo handling work indicated by a departure position included in the operation plan 3001-2, that is, the cargo handling start position. As a result, the automatic forklift 1 moves to the cargo handling start position which is the departure position by the travel device 7.

At the time of this movement, the arithmetic processing unit 111 records the operation type 3001-4 of the management data 3001 as moving. In addition, the arithmetic processing unit 111 receives the detection result from the laser curtains 21, that is, the safe state via the input/output unit 112 and records the result in the laser curtain 21 detection status 3001-5 of the storage unit 114. Furthermore, the arithmetic processing unit 111 receives the detection result from the laser scanner 2, that is, the safe state via the input/output unit 112 and records the result in the laser scanner 2 detection status 3001-6 of the storage unit 114.

Here, as described above, in a case where a foreign matter is not detected from the laser curtains 21 or the laser scanner 2, a safety signal is output. However, the laser curtains 21 and the laser scanner 2 may be configured to output a signal indicating a detection result, not limited to when a foreign matter is detected or a detection result. As described above, the safe state indicates a situation in which the presence of a foreign matter cannot be confirmed in a predetermined area in cargo handling, such as the safety monitoring area 211 and the vehicle safety monitoring range 4.

Then, if the arithmetic processing unit 111 detects that the automatic forklift 1 has arrived at the cargo handling start position, the processing proceeds to step S1113. For this detection, a GPS sensor, a gyro sensor, or the like, (not illustrated) may be used. The arithmetic processing unit 111 periodically or continuously receives a safety signal from the laser curtains 21 and the laser scanner 2 and corrects the content of the storage unit 114 in a case where this is stopped or in a case where there is a change in the result. In the present embodiment, the arithmetic processing unit 111 determines detection of a foreign matter by receiving a safety signal. However, the arithmetic processing unit 111 may be configured to receive a foreign matter detection signal indicating that a foreign matter is detected from the laser scanner 2 or the laser curtains 21. Furthermore, the arithmetic processing unit 111 may receive a detection result from the laser scanner 2 or the laser curtains 21 regardless of whether or not a foreign matter is detected and may determine the result. In this manner, the safe state of the safety monitoring area 211 can be monitored by the laser curtains 21 at the time of executing the cargo handling of the automatic forklift 1.

Next, in step S1113, the arithmetic processing unit 111 confirms the safe state detected by the laser curtains 21 at the cargo handling start position. For this purpose, the arithmetic processing unit 111 confirms whether or not a safety signal from the laser curtains 21 is continuously received. In this event, it is desirable that arithmetic processing unit 111 performs confirmation using the laser curtain 21 detection status 3001-5 of storage unit 114.

As a result, in a case where the safety signal is continuously received (safety signal is received, YES), it is determined that the safe state is confirmed, and the processing proceeds to step S1114. In a case where the safety signal from the laser curtains 21 cannot be received (safety signal is stopped, NO), the processing of this step is repeated, and the confirmation of the safe state is continued. In a case where the safety signal is stopped, the arithmetic processing unit 111 may determine that the state is in an unsafe state and stop the cargo handling work. Specifically, the arithmetic processing unit 111 desirably records that the cargo handling is stopped due to the unsafe state in at least one of the operation status 3001-3 and the operation type 3001-4 of the management data 3001 stored in the storage unit 114.

Next, in step S1114, the arithmetic processing unit 111 confirms the safe state in the laser scanner 2. Here, similarly to step S1113, it is confirmed whether the safety signal from the laser scanner 2 is continuously received. In this event, it is desirable that the arithmetic processing unit 111 performs confirmation using the laser scanner 2 detection status 3001-6 of the storage unit 114.

As a result, in a case where the safety signal is continuously received (safety signal is received: YES), it is determined that the safe state is confirmed, and the processing proceeds to step S1115. In a case where the safety signal from the laser scanner 2 is stopped and cannot be received (safety signal is stopped: NO), the processing of this step is repeated, and the confirmation of the safe state is continued. In a case where the safety signal is stopped, the arithmetic processing unit 111 may determine that the state is in an unsafe state and stop the cargo handling work. Specifically, the arithmetic processing unit 111 desirably records that the cargo handling is stopped due to the unsafe state in at least one of the operation status 3001-3 and the operation type 3001-4 of the management data 3001 stored in the storage unit 114.

Note that, in a case where the safe state is not confirmed for a predetermined period or a predetermined number of times stored in the storage unit 114 in steps S1113 and S1114, it is desirable that the arithmetic processing unit 111 notifies the management terminal 2000 and the work management server 3000 of the result. In particular, by notifying the management terminal 2000, it is possible to perform work and action for ensuring the safe state by the administrator himself/herself or by an instruction from the administrator to the worker.

Note that the processing of step S1114 may be omitted. In this case, in a case where the safe state in the laser curtains 21 is confirmed in step S1113, the processing proceeds to step S1116.

Next, in step S1115, the arithmetic processing unit 111 changes the vehicle safety monitoring range of the laser scanner 2. For example, the arithmetic processing unit 111 invalidates the vehicle safety monitoring range 4 in the laser scanner 2 as this change. Here, in the processing of step S1113, the laser curtain 21 detection status 3001-5 of the storage unit 114 indicates that the safety signal is received. In the processing of step S1114, the laser scanner 2 detection status 3001-6 in the storage unit 114 also indicates that the safety signal is received. Thus, in step S1115, the arithmetic processing unit 111 changes the vehicle safety monitoring range 4 in a case where the laser curtain 21 detection status 3001-5 and the laser scanner 2 detection status 3001-6 indicate that the safety signal is received. In other words, the arithmetic processing unit 111 changes the operation control 3001-7 of the laser scanner 2 to stop (invalidate). The example illustrated in FIG. in which the automatic forklift ID is “00002” corresponds to this case.

In the example where the automatic forklift ID is “00003”, the laser scanner 2 detection status 3001-6 indicates that the safety signal is stopped (a foreign matter is detected), and thus, the arithmetic processing unit 111 sets the operation control 3001-7 to maintain the operation of the laser scanner 2. In the example in which the automatic forklift ID is “00001”, the operation type 3001-4 indicates moving, that is, the automatic forklift does not arrive at the cargo handling start position. Thus, regardless of the laser curtain 21 detection status 3001-5 and the laser scanner 2 detection status 3001-6, the laser scanner 2 operation control 3001-7 is set to maintain the operation.

Then, the arithmetic processing unit 111 creates a control instruction to the laser scanner 2 according to the operation control of the laser scanner 2 and outputs the control instruction to the laser scanner 2.

Note that using the content stored in the storage unit 114 is merely an example, and the arithmetic processing unit 111 may make a determination by using the most recently output detection result from the laser curtains 21 or the laser scanner 2.

As an example of invalidation, the arithmetic processing unit 111 outputs a setting instruction to the laser scanner 2 so that the safety signal is continuously output regardless of the detection result of the laser scanner 2. The invalidation also includes stopping the function of the laser scanner 2 by the arithmetic processing unit 111 and maintaining the content of the laser scanner 2 detection status 3001-6 of the storage unit 114 to indicate that the safety signal is received. Further, the invalidation also includes that the arithmetic processing unit 111 interrupts the input while maintaining the function of the laser scanner 2 and maintains the content of the laser scanner 2 detection status 3001-6 of the storage unit 114 to indicate that the safety signal is received.

Here, the change of the vehicle safety monitoring range 4 includes aspects such as (1) invalidation (validation), (2) range/direction change, (3) quality change, (4) output power change, and (5) sensitivity change. (1) has been as described above, and thus, (2) to (5) will be briefly described below.

First, in (2) range/direction change, a direction of the scanning range is shifted by correcting a direction of the laser scanner 2. In this event, it is desirable to change a scanning area in a direction different from the cargo or the cargo handling device 3. A specific example of this aspect will be described in the second embodiment.

Next, in (3) quality change, similarly to the laser curtains 21, detection of a cargo is prevented by the muting function to enable selective detection of a foreign matter. Note that this aspect also includes switching from the laser scanner 2 to a human sensor using a camera or a temperature sensor.

In (4) output power change, an attenuation device is provided between the laser scanner 2 and the input/output unit 112, and a signal is attenuated so that the input/output unit 112 determines that the signal is noise. This can also be understood as a type of invalidation described above. In other words, even if noise is received, the content of the laser scanner 2 detection status 3001-6 of the storage unit 114 is maintained to indicate that the safety signal is received.

Finally, in (5) sensitivity change, the arithmetic processing unit 111 changes sensitivity serving as a reference for detecting a foreign matter in the laser scanner 2. As a result, even if a foreign matter such as a person is detected, a safety signal is output.

Note that each of the above aspects can be applied not only to a case where the laser scanner 2 outputs a safety signal but also to a case where the laser scanner 2 outputs a detection result regardless of whether or not a foreign matter is detected also in a case where a signal is output upon detection of a foreign matter.

Next, in step S1116, the arithmetic processing unit 111 creates a control instruction for performing cargo loading work as the cargo handling work and outputs the control instruction to the cargo handling control device 31. Then, if the cargo handling work is performed and completed, in step S1117, the arithmetic processing unit 111 detects end of the cargo loading work by using a detection result (the cargo is placed on the fork) of the cargo handling control device 31, other sensors, and the like.

Next, in step S1118, the arithmetic processing unit 111 restores the vehicle safety monitoring range 4 of the laser scanner 2. In other words, the arithmetic processing unit 111 creates a control instruction to return the change of the vehicle safety monitoring range 4 executed in scanner step S1115 to the previous range and outputs the control instruction to the laser scanner 2, or the like. The output destination is a device or a portion to be subjected to monitoring change.

Next, in step S1119, the arithmetic processing unit 111 determines whether the operation plan 3001-2 of the storage unit 114 has been completed. In the processing flow according to the present embodiment using the automatic forklift ID “0002” illustrated in FIG. 10, loading is completed, and there remains unloading work at a shipping position. Thus, in this example, the arithmetic processing unit 111 determines that the processing has not been completed (NO), and the processing returns to step S1112. In FIG. 6, the processing is expressed as loading in steps S1112, S11116, and S1117, but processing for unloading is executed here. In a case where the arithmetic processing unit 111 determines that the processing has been completed (YES), the processing ends.

This is the end of the description of the first embodiment. According to the present embodiment, even if a traveling sensor such as the laser scanner 2 or an in-vehicle sensor is invalidated at the time of cargo handling, it is possible to detect a foreign matter such as an intruder around the automatic forklift 1 by the cargo handling sensor or a sensor installed outside.

### Second Embodiment

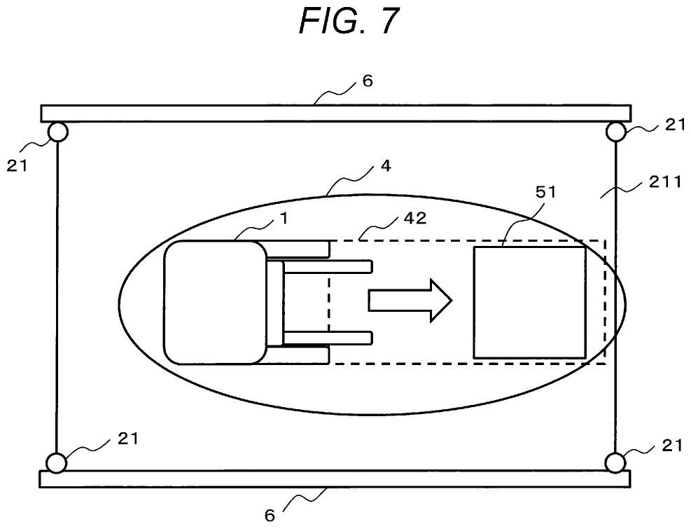

Next, a second embodiment of the present invention will be described with reference to FIG. 7. In the present embodiment, as a change of the vehicle safety monitoring range 4, an example of the above-described (2) range/direction change will be described. In FIG. 7, the same reference numerals as those in FIGS. 1 to 6 denote the same components, so that the description thereof will not be repeated.

FIG. 7 is a view illustrating a cargo handling operation state of the automatic forklift 1 according to the second embodiment. As illustrated in FIG. 7, in the present embodiment, in a case where the vehicle safety monitoring range 4 of the automatic forklift 1 is changed, the entire vehicle safety monitoring range 4 is not invalidated, but part thereof is invalidated, that is, the direction and the range are changed. Specifically, the vehicle control device 11 changes the vehicle safety monitoring range 4 to a range 42 on the basis of a work area of the cargo handling device 3. The range 42 is a rectangular region having the same width as the pallet 51 in the working direction of the cargo handling device 3. For this reason, it is desirable that the management data 3001 of the work management server 3000 or the storage unit 114 stores data regarding a size of the cargo to be handled. Alternatively, the size of the cargo may be detected by a sensor included in the laser scanner 2 or another automatic forklift 1.

According to the present embodiment, it is possible to detect a foreign matter such as an obstacle in an area other than the invalidation area even in a case where the range and direction of invalidation, or the like, of the laser scanner 2 is partially changed at the time of cargo handling.

### Third Embodiment

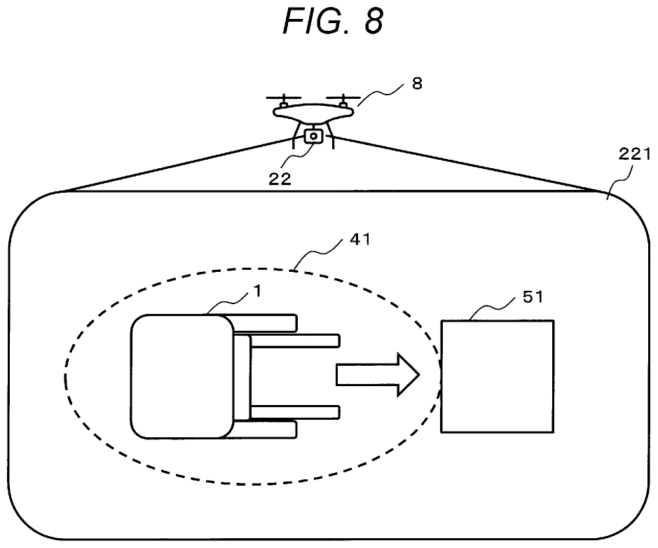

Next, a third embodiment of the present invention will be described with reference to FIG. 8. In the present embodiment, the safety monitoring device 22 provided in an autonomous flight vehicle 8 is used as the second safety monitoring device. Note that in FIG. 8, the same reference numerals as those in FIGS. 1 to 7 denote the same components, so that the description thereof will not be repeated.

FIG. 8 is a view illustrating a cargo handling operation state of the automatic forklift 1 according to the embodiment of the present invention. As illustrated in FIG. 8, the autonomous flight vehicle 8 includes a safety monitoring device 22 that can be implemented by a sensor or a camera. According to the present configuration, the autonomous flight vehicle 8 flies following the automatic forklift 1, and the vehicle control device 11 provides the safety monitoring area 221 in the present embodiment according to the detection result transmitted from the autonomous flight vehicle 8. As a result, the automatic forklift 1 can perform cargo handling work at an arbitrary place corresponding to the provided safety monitoring area 221. Note that the autonomous flight vehicle 8 is concept including an unmanned aerial vehicle (UAV).

### Fourth Embodiment

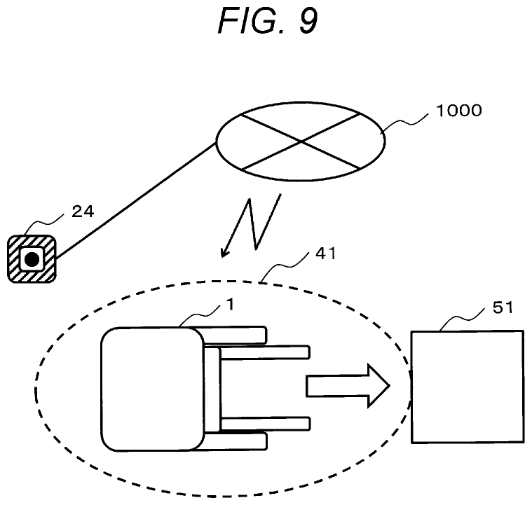

Next, a fourth embodiment of the present invention will be described with reference to FIG. 9. In the present embodiment, an emergency stop button 24 is provided as the second safety monitoring device. In FIG. 9, the same reference numerals as those in FIGS. 1 to 8 denote the same components, so that the description thereof will not be repeated.

FIG. 9 is a view illustrating a cargo handling operation state of the automatic forklift 1 according to the fourth embodiment of the present invention. As illustrated in FIG. 9, the emergency stop button 24 is provided as the second safety monitoring device.

The emergency stop button 24 outputs a safety signal in a case where the button is not pressed by the worker 50 and stops outputting the safety signal in a case where the button is pressed or in a case where there is some failure. The emergency stop button 24 transmits an output of the emergency stop button 24 to the automatic forklift 1 via the network 1000. Here, in a case where the safety signal is received, the vehicle control device 11 invalidates the vehicle safety monitoring range 4, for example, sets a vehicle safety monitoring invalidation range 41.

As described above, the output of the emergency stop button 24 which is the second safety monitoring device is not limited to the safety signal. In other words, the emergency stop button 24 may perform abnormality notification in a limited manner in a case where the button is pressed.

According to the present embodiment, when the automatic forklift 1 starts the cargo handling work, it is possible to determine whether or not the cargo handling can be performed on the basis of the state of the emergency stop button 24.

The present invention is not limited to the above-described embodiments and includes various modifications.

For example, the above-described embodiments have been described in detail for easy understanding of the present invention, and the present invention is not necessarily limited to those having all the described configurations. In addition, part of the components of a certain embodiment can be replaced with the components of another embodiment, and the components of another embodiment can be added to the configuration of a certain embodiment. In addition, it is possible to make addition, deletion, and replacement concerning part of the components of each embodiment.

### REFERENCE SIGNS LIST

1 automatic forklift
11 vehicle control device
111 arithmetic processing unit
112 input/output unit
113 communication unit
114 storage unit
2 laser scanner
21 laser curtain
211 safety monitoring area
23 communication device
3 cargo handling device
31 cargo handling control device
4 vehicle safety monitoring range
41 vehicle safety monitoring invalidation range
50 worker
51 pallet
6 wall
7 travel device
71 travel control device
2000 management terminal
3000 work management server
3001 management data

1. A vehicle control device that controls operation including movement and cargo handling in a cargo vehicle, the vehicle control device comprising:
an arithmetic processing unit configured to generate a control instruction for controlling the operation;
a communication unit connected to a travel control device that controls travel of the cargo vehicle and a cargo handling control device that controls cargo handling operation of the cargo vehicle and configured to output the control instruction; and
an input/output unit connected to a first safety monitoring device capable of monitoring a vehicle safety monitoring range and outputting safe state data for stopping operation of the cargo vehicle,
wherein in a case where a monitoring result of a safety monitoring area covering the vehicle safety monitoring range by a second safety monitoring device indicates a safe state when cargo handling by the cargo vehicle is executed, the arithmetic processing unit enables execution of the cargo handling by the cargo vehicle by changing the vehicle safety monitoring range.

2. The vehicle control device according to claim 1, wherein the arithmetic processing unit executes invalidation processing of the first safety monitoring device as change of the vehicle safety monitoring range.

3. The vehicle control device according to claim 1, wherein the arithmetic processing unit continues output of a safety signal regardless of a detection result in the first safety monitoring device as invalidation processing of the first safety monitoring device.

4. The vehicle control device according to claim 1, wherein the arithmetic processing unit restores the vehicle safety monitoring range that has been changed in a case where the cargo handling is finished.

5. A vehicle control method using a vehicle control device that controls operation including movement and cargo handling in a cargo vehicle,
the vehicle control device including an arithmetic processing unit configured to generate a control instruction for controlling the operation, a communication unit connected to a travel control device that controls travel of the cargo vehicle and a cargo handling control device that controls cargo handling operation of the cargo vehicle and configured to output the control instruction, and an input/output unit connected to a first safety monitoring device capable of monitoring a vehicle safety monitoring range and outputting safe state data for stopping operation of the cargo vehicle,
the vehicle control method comprising:
by the arithmetic processing unit,
receiving a monitoring result of a safety monitoring area covering the vehicle safety monitoring range by a second safety monitoring device when cargo handling by the cargo vehicle is executed; and
in a case where the monitoring result indicates a safe state, enabling execution of the cargo handling by the cargo vehicle by changing the vehicle safety monitoring range.

6. The vehicle control method according to claim 5, wherein the arithmetic processing unit executes invalidation processing of the first safety monitoring device as change of the vehicle safety monitoring range.

7. The vehicle control method according to claim 5, wherein the arithmetic processing unit continues output of a safety signal regardless of a detection result in the first safety monitoring device as invalidation processing of the first safety monitoring device.

8. The vehicle control method according to claim 5, wherein the arithmetic processing unit restores the vehicle safety monitoring range that has been changed in a case where the cargo handling is finished.
